(19) United States
(12) Patent Application Publication
(10) Pub. No.: US 2002/0041844 A1
(43) Pub. Date: Apr. 11, 2002

(54) Process for producing a CO/H2/N2 atmosphere through the oxidation of a gaseous hydrocarbon and plant for implementing it

(76) Inventors: Serban Cantacuzene, Massy (FR); Daniel Gary, Montigny Le Bretonneux (FR)

Correspondence Address: E. Joseph Gess, BURNS, DOANE, SWECKER & MATHIS, L.L.P., P.O. Box 1404, Alexandria, VA, 22313-1404, US

(21) Appl. No.: 09/907,612

(22) Filed: Jul. 19, 2001

(30) Foreign Application Priority Data
Jul. 19, 2000 (FR) 00 09470

(51) Int. Cl. B01J 8/04; B01J 10/00; F28D 1/00; C01B 3/26

(52) U.S. Cl. 423/651; 422/188; 422/198; 423/418.2

(57) ABSTRACT

Process for producing a CO/H₂/N₂ atmosphere through the oxidation of a gaseous hydrocarbon by an oxygen-containing medium in a catalytic bed reactor. The oxygen-containing medium is an O₂N₂ residual coming from a liquid removed from the bottom of a fractionating column for the production of gaseous nitrogen or the residual including nitrogen and oxygen, coming from the waste of an apparatus for separating air by a membrane technique. The invention includes a plant for carrying out the process.

The invention relates to the field of the production of atmospheres rich in hydrogen and in CO, the balance of which mainly consists of nitrogen. Such atmospheres can be used during metallurgical treatments that have to take place in a reducing atmosphere, such as certain annealing operations on carbon steels.

Such atmospheres are conventionally produced by generators installed on the site where the atmosphere is used. The main generators that exist fall within two families.

A first family of reactors uses as raw materials on the one hand impure nitrogen containing 1 to 5% oxygen, obtained by a permeation process, and on the other hand a hydrocarbon. They are made to react in a heated catalytic bed reactor (the reaction is endothermic) and a hydrogen/CO/nitrogen atmosphere is obtained whose nitrogen content depends especially on the composition of the starting gas. These reactors lack operating flexibility in that it is difficult for the composition of the atmosphere produced to be rapidly varied.

The second family of reactors uses the reaction of air with a hydrocarbon, carried out inside a heated catalytic bed reactor. The gas thus produced, which is generally richer in hydrogen and CO than desired by the user, is then diluted with nitrogen of cryogenic origin. Ideally, this cryogenic nitrogen is produced by a plant for generating pure nitrogen located on the same site as the catalytic bed reactor. The amount of dilution nitrogen may be varied in order to vary the composition of the atmosphere produced. However, in this way it is possible to produce only a limited range of atmosphere compositions if air is used as the raw material. Specifically, it is not possible to exceed a CO content of 20% and a hydrogen content of 40% at the outlet of the reactor and before dilution.

The object of the invention is to offer H₂/CO/N₂ atmosphere users a process and a plant for producing such an atmosphere which allows the range of possible compositions of this atmosphere to be widened, and to do so under more favourable economic conditions than the existing processes.

For this purpose, the subject of the invention is a process for producing an atmosphere comprising Co, hydrogen and nitrogen through the oxidation of a gaseous hydrocarbon by an oxygen-containing medium in a catalytic bed reactor, characterized in that the said oxygen-containing medium is a residual comprising nitrogen and oxygen, which comes from the oxygen-enriched liquid taken from the bottom of a fractionating column for the production of gaseous nitrogen and then vaporized or else coming from a residual comprising nitrogen and oxygen, coming from the waste (permeate) of an apparatus for separating air by a membrane technique.

The said waste comprising nitrogen and oxygen typically comprises from 35 to 40% oxygen and from 1.5 to 2% argon, the balance being nitrogen and impurities present in trace amounts (typically less than a few ppm).

The said oxygen-containing medium according to the invention generally represents only a fraction of the said waste produced by the said fractionating column, the said fraction being removed in the unexpanded state.

In the case of a residual coming from a membrane separator, the said atmosphere, comprising Co, hydrogen and nitrogen as output by the catalytic-bed reactor, advantageously undergoes a recompression step before being sent to a purification post-treatment unit comprising a system for recovering hydrogen by selective adsorption or PSA (Pressure Swing Absorption) system.

Advantageously, prior to the selective adsorption step, the said atmosphere has undergone a cooling step by heat exchange with water and a purification operation allowing condensation of all or some of the water that it contains and filtration of any soot generated during the catalytic reaction.

Preferably, the said waste is preheated before it is introduced into the reactor and the said preheat is preferably carried out by heat exchange with the CO/H₂/N₂ atmosphere coming from the reactor.

Preferably, as described in more detail later in the present application, the gaseous hydrocarbon is injected into the reactor by “staged” injection.

The invention also relates to a plant for producing an atmosphere comprising CO, hydrogen and nitrogen, through the oxidation of a gaseous hydrocarbon by an oxygen-containing medium in a catalytic bed reactor, characterized in that it comprises:

a unit for compressing and purifying atmospheric air;

a fractionating column producing, from compressed and filtered air, cryogenic gaseous nitrogen and a waste comprising nitrogen and oxygen which is deposited in the bottom of the column in the liquid state;

means for vaporizing the said waste, means for removing at least one portion of the said waste in the unexpanded gaseous state and means for introducing this portion removed from the said waste into the said reactor; and

means for introducing the gaseous hydrocarbon into the said reactor.

It also preferably comprises means for diluting the mixture comprising CO, hydrogen and nitrogen produced by the said reactor with cryogenic nitrogen produced by the said fractionating column.

The present invention also relates to a plant for producing an atmosphere comprising CO, hydrogen and nitrogen, through the oxidation of a gaseous hydrocarbon by an oxygen-containing medium in a catalytic bed reactor, characterized in that it comprises:

a unit for compressing and purifying atmospheric air;

an apparatus for separating air by a membrane technique, producing an oxygen-rich residual (permeate);

means for introducing all or some of this residual into the said reactor;

means for introducing the gaseous hydrocarbon into the said reactor;

means for recompressing the said atmosphere comprising Co, hydrogen and nitrogen as output by the catalytic bed reactor; and

means for directing the atmosphere coming from the said recompression means to a purification post-treatment unit comprising a system for recovering hydrogen by selective adsorption (PSA).

Advantageously, the plant includes, upstream of the said system for recovering hydrogen by selective adsorption (PSA), a system for cooling by heat exchange with water and a purification system allowing condensation of all or some of the water that the atmosphere contains and filtration of any soot generated during the catalytic reaction.

Preferably, the said means for introducing the gaseous hydrocarbon into the reactor comprise a plurality of pipes allowing the introduction of the said hydrocarbon to be distributed over various levels (depths) inside the said reactor (“staged” injection).

Preferably, the plant comprises a heat exchanger allowing the waste to be preheated by heat exchange with the atmosphere produced by the reactor.

Advantageously, the water recovered via the said condensation step is completely or partially recycled according to one or other of the following routes:

it is reinjected into the atmosphere obtained at the reactor outlet (thereby allowing the water content in the heat exchanger to be increased and having the effect of reducing the carbon activity and the phenomenon called “metal dusting”;

it is reinjected into the reactor inlet (this having the advantage of avoiding an excessively high NH₃ enrichment in the condensate).

Preferably, the plant comprises means for preheating the O₂/N₂ waste before its introduction into the reactor or at the time of introduction, at least during the periods in which the said reactor is not operating in a thermal steady state.

The catalytic bed of the said reactor can also include at least one heat-resistant material having a better thermal conductivity than the material or materials used as catalyst in the said catalytic bed.

The said heat-resistant material having a better thermal conductivity than the material or materials used as catalyst is, for example, chosen from silicon carbide, boron nitride and aluminium nitride.

The material or materials used as catalyst and the heat-resistant material or materials having a better thermal conductivity than them are mixed within the catalytic bed, or else are placed in alternating layers inside the reactor.

The said reactor preferably has an outer wall, an inner wall concentric with it and a thermally insulating material filling the annular space defined by the said outer wall and the said inner wall.

The upper portion of the said inner wall is preferably not connected to the said outer wall.

As will have been understood, the invention is based on the replacement of air (or of impure nitrogen), conventionally used as oxidizer in generators of H₂/CO/N₂-type atmospheres, with a gas mixture comprising nitrogen and oxygen, such as that coming from the oxygen-enriched liquid which has been removed from the bottom of a fractionating column for the production of gaseous nitrogen or else as coming from the permeate of a membrane air separator.

The invention will be more clearly understood on reading the description which follows, given with reference to the following appended figures:

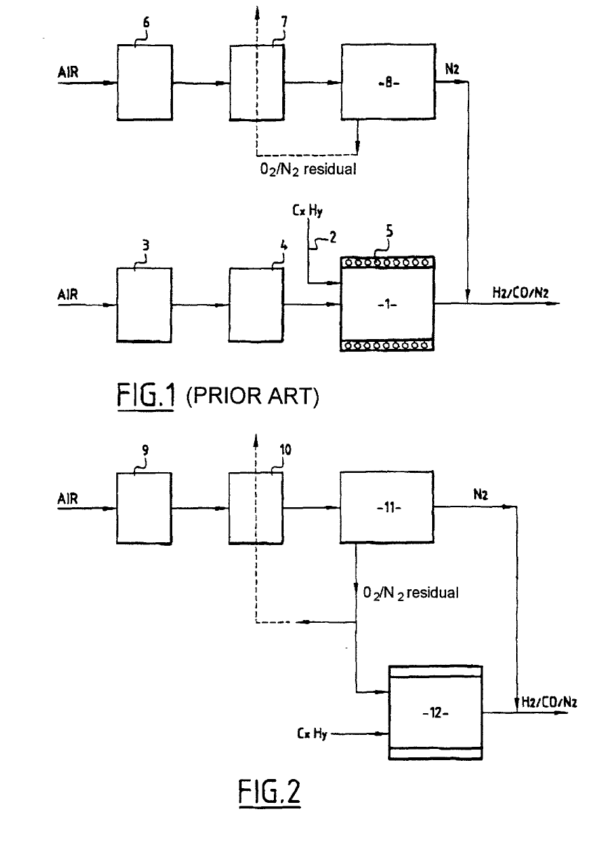

FIG. 1, which shows schematically one type of plant for producing an H₂/CO/N₂ mixture according to the prior art;

FIG. 2, which shows schematically a plant for producing an H₂/CO/N₂ mixture according to the invention;

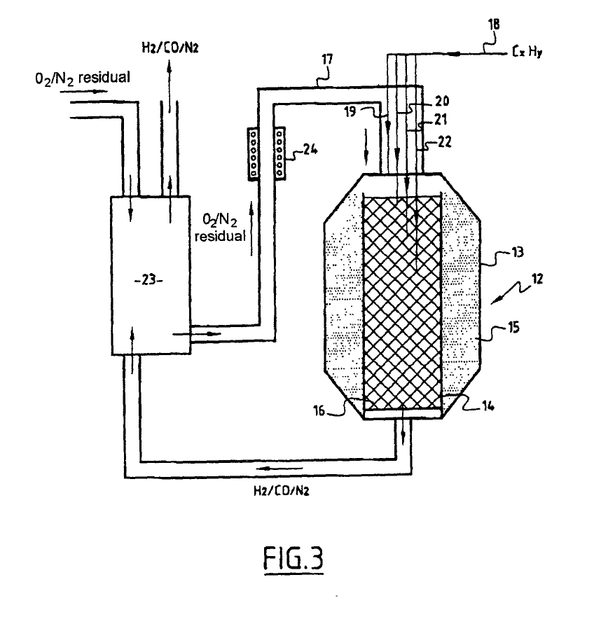

FIG. 3, which shows schematically, seen in longitudinal section, a preferred example of a generator of an H₂/CO/N₂ atmosphere which can be used in a plant according to the invention, together with its appendages.

An example of a description of a plant for producing cryogenic nitrogen from compressed air is described in document EP-B1-0 343 065. In such a plant, the air used as raw material is compressed and then purified of the moisture and CO₂ that it contains in an adsorption-type purification unit. After cooling in a heat exchanger to a temperature close to its liquefaction point, it is introduced into a fractionating column. In the upper portion of this column, low-temperature gaseous nitrogen, which is used as coolant in the aforementioned heat exchanger, is collected before storing it or delivering it directly to the customer. An oxygen-enriched liquid typically containing approximately 35% to 40% oxygen and 1.5 to 2% argon, the balance being nitrogen (and inevitable impurities in trace amounts) for approximately 60 to 65%, is collected in the lower portion of the column. This liquid may, as described in document EP-B1-0 343 065, be removed in order to be used as coolant in a condenser located at the top of the fractionating column. It emerges therefrom in the gaseous state. Next, advantageously, it too is used as coolant in the aforementioned heat exchanger and then, once expanded, it may at least partly be used periodically for regenerating the reaction media of the adsorption unit, before being exhausted to the outside of the unit. This exhaust gas is conventionally called “waste” or “O₂/N₂ waste” in the literature, and it is the latter term that will be used to denote it in the rest of this description. Document EP-B1-0 343 065 also teaches the use of the non-exhausted portion of this O₂/N₂ waste at other points in the fractionating column and in its appendages.

In the known plants for producing cryogenic nitrogen comprising not one but two superposed fractionating columns, a similar O₂/N₂ waste is collected at the bottom of the lower column operating at medium pressure and is introduced in the upper column operating at low pressure.

The plant according to the prior art shown schematically in FIG. 1 includes, as an essential element, an endothermic generator comprising a reactor 1 having a catalytic bed based on, for example, a precious metal (platinum, palladium, etc.) deposited on a silica or alumina support, in which the chemical reaction of oxidation of a hydrocarbon CₓH_{y}, such as methane (or, for example, propane or LPG), takes place by an oxygen-containing medium such as air. The hydrocarbon CₓH_{y} is introduced into the reactor 1 via a line 2. The air used as raw material is firstly compressed in a compressor 3 and then stripped of certain of its contaminants in a filtration unit 4, the said contaminants possibly constituting “poisons” for the catalyst. Inside the generator 1 the following reactions take place (as non-limiting example, methane is used below as oxidizer):

partial oxidation of methane according to

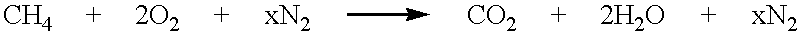

(exothermic reaction)

and then the endothermic reforming reactions:

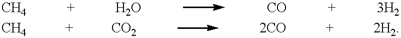

It is usually necessary to provide the reactor 1 with heating means, such as electrical resistance heating elements 5 built into the wall of the reactor 1, or burners. Their function is to raise the temperature of the catalytic bed to a level high enough for the endothermic reactions to take place at a high rate so that the residual CO₂ and H₂₀ contents of the mixture on the output side of the reactor are as low as possible. In practice, the endothermic gas collected at the output side of the reactor 1 is composed of approximately 20% CO, 40% H₂ and 40% N₂.

In parallel with this unit for producing an H₂/CO/N₂ mixture, the plant in FIG. 1 includes a unit for producing cryogenic nitrogen from air taken from the atmosphere. It includes a compressor 6 and an adsorption-type purification unit 7 which especially strips the compressed air of CO₂, water and most of the contaminants that it contains (CxHy, Nox, Sox, etc.) The air thus purified is introduced into a fractionating column 8, from which cryogenic nitrogen emerges. This cryogenic nitrogen is then mixed with the gases coming from the reactor 1 so as to dilute these gases (too rich in CO and H₂ for some applications). Thus, an atmosphere suitable for the requirements of the user is obtained, such as an atmosphere containing 5% CO, 10% H₂ and 85% N₂ for annealing carbon steels. Collected at the bottom of the fractionating column 8 is the usual O₂/N₂ waste containing approximately 35 to 40% oxygen and 60 to 65% nitrogen which, in the case illustrated, is finally discharged into the open air after having been expanded and possibly having to contribute to the regeneration of the materials of the adsorption unit.

The plant according to the invention, shown schematically in FIG. 2, includes, as previously, a unit for producing cryogenic nitrogen from air taken from the atmosphere. Again there is a compressor 9, an adsorption-type purification unit 10 and a cooling column 11 which produces cryogenic nitrogen and an O₂/N₂ waste.

However, according to the invention, at least one fraction of this O₂/N₂ waste in the gaseous state, but not yet expanded, is used as oxidizer instead of air in the reactor 12 producing the desired H₂/CO/N₂ mixture. Moreover, this reactor 12 is fed with a hydrocarbon XₓH_{y} such as methane. The mixture output by the reactor 12 is diluted, where appropriate, with cryogenic nitrogen coming from the fractionating column 11 so as to obtain the composition desired by the user.

Compared with the prior art shown schematically in FIG. 1, the plant according to the invention and the process on which it is based have several advantages.

Firstly, it is now necessary to have only a single combination (9, 10) of air compression and purification apparatuses instead of two (3, 4; 6, 7).

Secondly, since the O₂/N₂ waste has an oxygen content of about 35 to 40%, and therefore substantially greater than that of air, a gas mixture is thus output by the reactor 12 which is richer in CO and in H₂ than the mixture output by the reactor of the plant according to the prior art. Typically, these gas mixtures have the following compositions:

| | Prior art | Invention |
|---|---|---|
| H₂ | 40% | 52% |
| CO | 20% | 26% |
| N₂ | 40% | 22% |

A wider range of atmosphere compositions than in the prior art is therefore available.

In order to return to the usual atmospheres output by the plant, it is merely a question of varying the amount of dilution nitrogen added, which is extracted from the fractionating column 11 without any additional cost.

Since this O₂/N₂ waste, being in any case produced by the fractionating column 11, is also present in the plant according to the prior art (and in general discharged without being utilized), it therefore constitutes a free raw material not requiring any particular treatment (if it is removed in the gaseous state but still not yet expanded, and therefore before its possible passage through the adsorption unit 10). Measures simply have to be taken to ensure that, if the O₂/N₂ waste is also used for other purposes before being discharged into the atmosphere, for example for periodically regenerating the adsorption unit 10, or recycled into the fractionating column 11 and/or its appendages, the amount removed for feeding the endothermic reactor 12 is not too great. Otherwise, the proper operation of the units using the O₂/N₂ waste could be disturbed. In practice, it has in fact been found that removing a few per cent of this O₂/N₂ waste is sufficient for suitably operating the plant according to the invention, given the usual dimensions of its various components. Under these conditions, the periodic regeneration of the adsorption unit 10 can, for example, still be correctly carried out.

Another very significant advantage of the invention is that the greater oxygen supply here than in the case of the use of air as oxidizer increases the amount of heat released inside the reactor 12 by the exothermic hydrocarbon oxidation reaction. If the reactor 12 is thermally insulated well enough (which can be achieved by conventional lagging means), this amount of heat is sufficient to constitute the heat supply needed for carrying out the endothermic reforming reactions properly, at least when the reactor 12 is operating in the steady state. It is therefore no longer necessary to provide a heating device around the reactor and/or inside the reactor, as was the case for the endothermic generator of the plant according to the prior art. The additional amount of heat that it may be necessary to supply to the system during the start up phases of the reactor 12 may be provided by a simple gas preheat unit located before the inlet of the reactor 12 or right in the inlet of the latter. Measures must simply be taken to ensure that the catalytic bed is not raised to an excessive temperature which would degrade it.

Compared with air, the O₂/N₂ waste used by the invention also has the advantage of having a stable composition, whereas air may contain, even after it is filtered at 4, compounds which would be contaminants for the catalytic bed and a certain amount of residual water vapour. Typically, this O₂/N₂ waste has the following composition:

O₂: 35-40%

Ar: 1.5-2% (its presence is not a problem for the various uses of the atmospheres produced and even tends to homogenize the temperature of the gases)

CO₂<1 ppm

H₂O<1 ppm

CₓH_{y}<1 ppm, except CH₄<10 ppm

S<1 ppm

N₂: balance to 100%.

The absence in the O₂/N₂ waste of poisons for the catalysts makes it possible for the lifetime of the catalytic bed of the reactor 12 to be substantially extended. This results in an excellent productivity of the plant of the invention compared with the plant according to the prior art, since the number of times the plant is shut down in order to replace the catalyst is markedly reduced.

The possibility of dispensing with a device for heating the reactor 12 allows its construction to be considerably simplified compared with the generators of the prior art which must incorporate such a heating device 5. In addition, the reactors of the prior art must have a thin metal internal wall so as to be able to achieve good heat transfer between the external heating device 5 and the catalytic bed. However, this thin wall is thus exposed to high thermal stresses and tends to deteriorate rapidly if it is not made of a high-quality steel. And even under these conditions, the framework of the reactor 1 must generally be replaced approximately every two years.

The invention makes it possible to use a reactor 12 with no heating means and a preferred example of its design is shown schematically in FIG. 3.

This reactor 12 is conventionally placed in a vertical overall orientation and the gases which flow therein pass through it from the top down in order to prevent fluidization of the solid materials present in the reactor 12. It has an outer wall 13, for example of cylindrical overall shape, and an inner wall 14 concentric with the outer wall 13, therefore defining with it an annular space filled with a thermally insulating material 15, such as a fibrous refractory or a material in the form of beads. The inner wall 14 is the one more thermally stressed since it is in direct contact with the catalytic bed 16 and the hot gases which flow through the reactor 12. However, since it fulfills no function of heat transfer between a heating member and the catalytic bed 16 (unlike the inner wall of the reactor of the plant of the prior art), this inner wall may have a relatively large thickness, thereby reducing its risk of being degraded. Moreover, such degradation (by cracking and/or corrosion) would not have too serious immediate consequences since the outer wall 13 thermally protected by the insulating material 15 would continue to prevent gases from leaking into the external environment. The inner wall 14 can therefore be made of a lower-performance material than in the prior art, which contributes to making the construction of the reactor more economical.

Advantageously, as shown, the inner wall 14 has its upper end left free, not in contact with the upper part of the outer wall 13. This allows the inner wall 14 to expand and contract freely during the heat cycles that it undergoes, and to react in a flexible manner to the pressure variations inside the reactor 12. This feature therefore allows the operating time of the generator between two complete refits to be extended.

The reactor 12 thus constructed may also withstand high working pressures, by virtue of which the H₂/CO/N₂ mixture produced may be delivered under pressure to the customer, without having to be subsequently compressed.

In the reactor shown in FIG. 3, the O₂/N₂ waste is conveyed to the upper part of the reactor by a pipe 17. In addition, a pipe 18 conveys the hydrocarbon used as fuel thereto. It would be acceptable to inject all this hydrocarbon at the inlet of the reactor 12 and therefore at the same level as the O₂/N₂ waste. However, it is advantageous, as shown in FIG. 3, for this injection to be carried out in a “staged” manner, by distributing it over, for example, four different depth levels into the reactor 12 by means of four pipes 19, 20, 21 and 22 which are tapped off the main pipe 18 and provided with distribution valves (not shown).

This is because if all of the hydrocarbon is injected at a single level, for example at the inlet of the reactor 12, there is a risk of incomplete combustion of the hydrocarbon which would end up in the formation of soot. Now, such a formation of soot would be highly damaging to the performance of the catalyst, the pores of which would become progressively clogged up. In general, soot would progressively foul the pipes, which would need to be periodically cleaned. The productivity and the reliability of the plant would therefore be degraded. A staged injection of hydrocarbon allows the risk of incomplete combustion, and therefore the formation soot, to be reduced. Thus, it is possible, for example, to propose injecting 10% of the total amount of hydrocarbon at the inlet of the reactor 12 and 30% of this amount at each of the other three injection levels. Furthermore, this mode of injection has the advantage of extending the region of the catalytic bed 16 where heat is dissipated, something which is favourable for establishing the endothermic reforming reactions uniformly over at least the greater part of the height of the catalytic bed 16. In total, a gas outlet temperature is obtained which is a few tens of degrees higher than in the case in which there is a single point of injection of the hydrocarbon at the inlet of the reactor 12. Above all, excessive localized overheating of the reactor 12 near the single point of injection of the hydrocarbon is avoided, which overheating could rapidly degrade thereat the catalytic bed 16 and the reactor 12.

Another feature that may be advantageously conferred on the reactor 12 is to partially replace the silica and/or alumina beads most commonly used to form the catalytic bed with beads of a material (or of several materials) which is a better heat conductor, such as silicon carbide or aluminium or boron nitrides. These materials have a good chemical resistance to the gases passing through the reactor 12, at least in the regions where there is no longer oxygen. The advantage of mixing these refractories having a relatively good thermal conductivity with the alumina or silica beads, which are poor conductors, is to reduce the temperature gradient between the top and bottom parts of the reactor 12 and also the radial thermal gradients at the various levels of the wall 14. As a variant, layers of catalyst and layers of the more conducting material may alternate inside the reactor 12.

Advantageously, according to the invention, the reactor 12 (or a reactor similar in its operating principle) is included in a circuit as shown in FIG. 3, in which the hot H₂/CO/N₂ mixture produced passes through a heat exchanger 23 where its temperature is lowered to approximately 400° C. before it is delivered to the customer. This temperature reduction makes it possible to guarantee that the composition of the mixture is stable. Moreover, this cooling takes place advantageously by heat exchange with the O₂/N₂ waste coming from the fractionating column 11, which is thus heated to approximately 700° C. before it is injected into the reactor 12. Preferably, a heater 24 is installed on the line 17 which conveys the O₂/N₂ waste from the exchanger 23 to the reactor 12. It makes it possible to obtain, reliably, at least at the start of a cycle when the reactor 12 is not yet operating in a thermally stabilized manner, a sufficient temperature of the waste at its entry into the reactor 12. This heater 24 may be replaced by a burner located at the inlet of the reactor 12.

It goes without saying, without departing from the scope of the invention, that modifications may be made to the process and to the plant that have just been described. In particular, if the CO/H₂/N₂ atmosphere as produced by the reactor 12 is suitable for the user, it is possible to dispense with the dilution with the cryogenic nitrogen produced by the fractionating column 11 and to use this nitrogen for other purposes or to store it. Conversely, if the amount of cryogenic nitrogen produced is insufficient to ensure the desired dilution, this dilution may be supplemented by means of a supply of nitrogen external to the plant.

Although the invention has been more particularly illustrated in the foregoing by the case of oxygen-enriched liquid which has been withdrawn from the bottom of a fractionating column for the production of gaseous nitrogen, it will be clearly apparent to those skilled in the art that the alternative way of implementing the invention, in which the oxygen-containing medium comes from the residual comprising nitrogen and oxygen, coming from the waste (permeate) of an apparatus for separating air by a membrane technique, is also very effective and advantageous:

the oxygen richness of the permeate can be adjusted by adjusting the operating parameters of the separating unit;

it allows (just as in the case of the fractionating column) the amount of hydrogen produced to be significantly increased over the prior art in order to reach approximately 50% (with an overall content of H₂ and CO reducing species close to 75 to 80%).

1. Process for producing an atmosphere comprising CO, hydrogen and oxygen through the oxidation of a gaseous hydrocarbon by an oxygen-containing medium in a catalytic bed reactor, characterized in that the said oxygen-containing medium comes from one or other of the following sources:
a residual comprising nitrogen and oxygen, coming from the oxygen-enriched liquid taken from the bottom of a fractionating column for the production of gaseous nitrogen and then vaporized;
a residual comprising nitrogen and oxygen, coming from the waste of an apparatus for separating air by a membrane technique.

2. Process according to claim 1, characterized in that the said oxygen-containing medium comes from a residual comprising nitrogen and oxygen, coming from the oxygen-enriched liquid taken from the bottom of a fractionating column for the production of gaseous nitrogen and then vaporized.

3. Process according to claim 2, characterized in that the said residual contains from 1.5 to 2% argon.

4. Process according to claim 1, characterized in that the said oxygen-containing medium comes from a residual comprising nitrogen and oxygen, coming from the waste of an apparatus for separating air by a membrane technique.

5. Process according to claim 4, characterized in that the said atmosphere comprising CO, hydrogen and nitrogen as output by the catalytic bed reactor undergoes a recompression step before being sent to a purification post-treatment unit comprising a system for recovering hydrogen by selective adsorption (PSA).

6. Process according to claim 5, characterized in that, prior to the selective adsorption step, the said atmosphere has undergone a cooling step by heat exchange with water and a purification operation allowing condensation of all or some of the water that it contains and filtration of any soot generated during the catalytic reaction.

7. Process according to claim 6, characterized in that the water thus recovered is completely or partially recycled according to one to the other of the following routes:
it is reinjected into the atmosphere obtained at the reactor outlet;
it is reinjected into the reactor inlet.

8. Process according to one of the preceding claims, characterized in that the said waste contains from 35 to 40% oxygen.

9. Process according to either of claims 1 and 2, characterized in that the said oxygen-containing medium represents only a fraction of the said waste produced by the said fractionating column, the said fraction being removed in the unexpanded state.

10. Process according to one of the preceding claims, characterized in that the said waste is preheated before it is introduced into the reactor and in that the said preheat is carried out by heat exchange with the atmosphere produced by the reactor.

11. Process according to one of the preceding claims, characterized in that the gaseous hydrocarbon is injected into the reactor by “staged” injection.

12. Plant for producing an atmosphere comprising CO, hydrogen and nitrogen, through the oxidation of a gaseous hydrocarbon by an oxygen-containing medium in a catalytic bed (16) reactor (12), characterized in that it comprises:
a unit (9, 10) for compressing and purifying atmospheric air;
a fractionating column (11) producing, from compressed and filtered air, cryogenic gaseous nitrogen and a waste comprising nitrogen and oxygen which is deposited in the bottom of the column in the liquid state;
means for vaporizing the said waste, means for removing at least one portion of the said waste in the unexpanded gaseous state and means for introducing this portion removed from the said waste into the said reactor; and
means for introducing the gaseous hydrocarbon into the said reactor (12).

13. Plant according to claim 12, characterized in that it comprises means for diluting the mixture comprising CO, hydrogen and nitrogen produced by the said reactor with cryogenic nitrogen produced by the said fractionating column.

14. Plant for producing an atmosphere comprising CO, hydrogen and nitrogen, through the oxidation of a gaseous hydrocarbon by an oxygen-containing medium in a catalytic bed (16) reactor (12), characterized in that it comprises:
a unit (9, 10) for compressing and purifying atmospheric air;
an apparatus for separating air by a membrane technique, producing an oxygen-rich residual (permeate);
means for introducing all or some of this residual into the said reactor;
means for introducing the gaseous hydrocarbon into the said reactor (12);
means for recompressing the said atmosphere comprising CO, hydrogen and nitrogen as output by the catalytic bed reactor; and
means for directing the atmosphere coming from the said recompression means to a purification post-treatment unit comprising a system for recovering hydrogen by selective adsorption (PSA).

15. Plant according to claim 14, characterized in that it comprises, upstream of the said system for recovering hydrogen by selective adsorption (PSA), a system for cooling by heat exchange with water and a purification system allowing condensation of all or some of the water that the atmosphere contains and filtration of any soot generated during the catalytic reaction.

16. Plant according to claim 15, characterized in that it comprises means for completely or partially recycling the water thus recovered, according to one or other of the following routes:
for reinjecting it into the atmosphere obtained at the reactor outlet;
for reinjecting it into the reactor inlet.

17. Plant according to one of claims 12 to 16, characterized in that the said means for introducing the gaseous hydrocarbon into the reactor (12) comprise a plurality of pipes (19, 20, 21, 22) allowing the introduction of the said hydrocarbon to be distributed over various levels (depths) inside the said reactor.

18. Plant according to one of claims 12 to 17, characterized in that it comprises a heat exchanger (23) allowing the waste to be preheated by heat exchange with the atmosphere produced by the reactor.

19. Plant according to one of claims 12 to 18, characterized in that it comprises means (24) for preheating the waste before its introduction into the reactor (12) or at the time of introduction, at least during the periods in which the said reactor (12) is not operating in a thermal steady state.

20. Plant according to one of claims 12 to 19, characterized in that the catalytic bed (16) of the said reactor (12) also includes at least one heat-resistant material having a better thermal conductivity than the material or materials used as catalyst in the said catalytic bed (16).

21. Plant according to claim 20, characterized in that the said heat-resistant material having a better thermal conductivity than the material or materials used as catalyst is, for example, chosen from silicon carbide, boron nitride and aluminium nitride.

22. Plant according to claim 20 or 21, characterized in that the material or materials used as catalyst and the heat-resistant material or materials having a better thermal conductivity than them are mixed within the catalytic bed (16).

23. Plant according to claim 20 or 21, characterized in that the material or materials used as catalyst and the heat-resistant material or materials having a better thermal conductivity than them are placed in alternating layers inside the reactor (12).

24. Plant according to one of claims 12 to 23, characterized in that the said reactor (12), has an outer wall (13), an inner wall (14) concentric with it and a thermally insulating material (15) filling the annular space defined by the said outer wall (13) and the said inner wall (14).

25. Plant according to claim 24, characterized in that the upper portion of the said inner wall (14) is not connected to the said outer wall (13).
